(19) United States
(12) Patent Application Publication
(10) Pub. No.: US 2016/0299734 A1
(43) Pub. Date: Oct. 13, 2016

(54) IMAGE MIRROR DISPLAY METHOD AND DEVICE THEREOF

(71) Applicant: BEIJING SUNPLUS-EHUE TECH CO.,LTD., Beijing (CN)

(72) Inventors: Wei QIN, Beijing (CN); Tai-Yun WANG, Beijing (CN); Peng-Fei TAN, Beijing (CN)

(73) Assignees: Beijing Sunplus-EHue Tech Co., Ltd., Beijing (CN); Sunplus Technology Co., Ltd., Hsinchu (TW)

(21) Appl. No.: 15/038,040

(22) PCT Filed: Nov. 6, 2015
(86) PCT No.: PCT/CN2015/094040

§ 371 Date: May 19, 2016

(30) Foreign Application Priority Data
Nov. 6, 2014 (CN) 201410638090.7

(51) Int. Cl. G06F 3/14; G06T 1/00

(52) U.S. Cl. CPC G06F 3/1454; G06T 1/0007; H04W 88/02

(57) ABSTRACT

An image mirror display method for an Android data processing system is provided. The method includes: executing a pre-stored virtual display screen record procedure by an Android Shell user privilege for obtaining images displayed on a virtual display of the Android data processing system, wherein the images displayed on the virtual display are the same as current images displayed on an internal display of the Android data processing system; processing and storing the images displayed on the virtual display of the Android data processing system; and sending the stored images displayed on the virtual display of the Android data processing system to an external display device via a communication channel, wherein the Android data processing system and the external display device are coupled via the communication channel.

This application is the 35 U.S.C. §371 national stage of PCT application serial no. PCT/CN2015/094040, filed Nov. 6, 2015, which claims the benefit of People's Republic of China application serial no. 201410638090.7, filed on Nov. 6, 2014, the disclosure of which is hereby incorporated by reference.

### TECHNICAL FIELD

The disclosure relates in general to an image display technology field, and more particularly to an image mirror display method and device thereof.

### BACKGROUND

Usually, computers, mobile phones, PDAs (personal digital assistance) or other electronic devices has an internal display which displays image or data generated by or stored in the electronic device.

Because the internal display of the electronic device is limited by the size and functions, the internal display of the electronic device usually does not have good display effect. By the current image mirror display technology, the electronic device is coupled to an external device and thus the internal display of the electronic device and the external display of the external device show the same image data at the same time, which is called a mirrored mode.

China patent application publication CN102681810, published on Sep. 19, 2012, discloses sending mirror images into an external display. The data processing system combines image contents generated by the applications executed on the data processing system into image data. The data processing system stores the image data into a first frame buffer and displays the image generated from the image data stored in the first frame buffer on the internal display of the data processing system. The scaler of the data processing system performs scaling operations on the image data of the first frame buffer, stores the scaled image data into a second frame buffer and displays the images generated from the scaled image data in the second frame buffer on the external display device coupled to the data processing system. Scaling operation is performed asynchronously by the scaler and generation of the image contents. The data processing system automatically mirrors the images to the external display device unless the application is displaying other image contents on the external display device. However, the data processing system in the reference document needs the scaler, the first and the second frame buffers to realize image mirror display. The reference document needs to amend the procedures of the data processing system, which causes much variation to the data processing system. Thus, the reference document does not realize direct image mirror display on the external display via the current data processing system.

China patent application publication CN102377877, published on Mar. 14, 2012, discloses a mirror display method for a user device which concurrently performs wireless transmission of a compressed first source document and a first display message corresponding with the first source document to another user device and coding of the first source document in response to a first type of display mirror request. Based on the first display message, the encoding result of the first source document is displayed, and the first source document is displayed on another user device. However, in this reference document, the mirror image display is in wireless. In the environment where no wireless network signal is available, not only the first display message cannot be transmitted wireless, but also the image mirror display is not achieved. Further, in the reference document, the image display consumes the wireless bandwidth and delays the image display.

China patent application publication CN103581337, published on Feb. 12, 2014, discloses a smart phone and an on-board unit. A method including the following steps: a) connecting the smart phone and the on-board unit via an independent display channel and a reactive channel; b) mirroring display contents from the smart phone to the display of the on-board unit via the display channel; and c) mirroring operations from the on-board unit to the smart phone via the reactive channel. The display channel is USB or HDMI. However, two channels between the smart phone and the on-board unit are needed, i.e. the display channel and the reactive channel. In the reference document, a root (system administrator) privilege of the smart phone is needed to implement image mirror transmission and processing on the smart phone. This may damage the current security system on the smart phone and thus the smart phone manufacture does not provide maintenance service to the smart phone.

### SUMMARY

In order to solve one of the technical problems, the application provides an image mirror display method and device thereof, which realizes the image mirror display between the current data processing system and the external display device even without the root privilege on the current data processing system. Thus, there is no need to have a large variation on the current data processing system.

In order to achieve one of the above objects, embodiments of the application provides the following implementations.

According to one embodiment, an image mirror display method for an Android data processing system is provided. The method includes: executing a pre-stored virtual display screen record procedure by an Android Shell user privilege for obtaining images displayed on a virtual display of the Android data processing system, wherein the images displayed on the virtual display are the same as current images displayed on an internal display of the Android data processing system; processing and storing the images displayed on the virtual display of the Android data processing system; and sending the stored images displayed on the virtual display of the Android data processing system to an external display device via a communication channel, wherein the Android data processing system and the external display device are coupled via the communication channel.

In an embodiment of the application, pre-storage of the virtual display screen record procedure includes the following steps: storing the virtual display screen record procedure into a storage space of the Android data processing system by a record command of an Android adjustment bridge ADB; encoding and storing an Android Java procedure into the Android data processing system to obtain a directory space controlled by the Android Java procedure; executing the Android Java procedure to record the virtual display screen record procedure stored in the storage space of the Android data processing system into the directory space controlled by the Android Java procedure; and informing the Android Shell user privilege about a name of the directory space, and amending a document property of the virtual display screen record procedure as an executable document which is executable by other user privilege.

In an embodiment of the application, the Android Java procedure is stored into the Android data processing system in form of an Android application package apk.

In an embodiment of the application, execution of the pre-stored virtual display screen record procedure by the Android Shell user privilege is achieved by executing the virtual display screen record procedure stored in the directory space via an adb Shell command input into the Android data processing system.

In an embodiment of the application, pre-storage of the virtual display screen record procedure includes the following steps: storing the virtual display screen record procedure into a directory (which is writable by the Android Shell user privilege) of a storage space of the Android data processing system by a record command of an Android adjustment bridge ADB; and amending a property of the virtual display screen record procedure as an executable document having “s-property” via an adb Shell command of the Android adjustment bridge ADB.

In an embodiment of the application, pre-storage of the virtual display screen record procedure includes the following steps: establishing a new directory in a directory (which is writable by the Android Shell user privilege) of a storage space of the Android data processing system; setting a property of the new directory as “t-property” via a record command of an Android adjustment bridge ADB; storing the virtual display screen record procedure into the new “t-property” directory of the storage space of the Android data processing system by the record command of the Android adjustment bridge ADB; and amending a property of the virtual display screen record procedure as an executable document having “s-property” via the record command of the Android adjustment bridge ADB.

In an embodiment of the application, the step of executing the pre-stored virtual display screen record procedure by the Android Shell user privilege is achieved by calling the virtual display screen record procedure by a procedure of an Android application package apk.

In an embodiment of the application, the step of processing and storing the current images displayed on the internal display of the Android data processing system is to compress the current images displayed on the internal display into a video stream flow compatible with H.264 standard.

In an embodiment of the application, a multimedia frame structure processing flow “Stagefright” of Android is used to process the current images displayed on the internal display.

In an embodiment of the application, a hardware encoder is used to compress the current images displayed on the internal display into a video stream flow compatible with H.264 standard.

In an embodiment of the application, the communication channel is implemented by corresponding a TCP port of the Android data processing system with a TCP port of the external display device.

In an embodiment of the application, the communication channel is implemented by a USB cable.

In an embodiment of the application, the communication channel is implemented by USB network share.

In an embodiment of the application, the method further includes amending a property of a SELinux context of the virtual display screen record procedure by a command, and thus the virtual display screen record procedure is executed by the Android Shell user privilege.

The application further provides an image mirror display method for an external display device. The method includes: receiving images displayed on a virtual display of an Android data processing system from the Android data processing system by the external display device via a communication channel, wherein the external display device is coupled to the Android data processing system via the communication channel, and the images displayed on the virtual display are the same as images currently displayed on an internal display of the Android data processing system; and processing and displaying the received images displayed on the virtual display of the Android data processing system.

In an embodiment of the application, the communication channel is implemented by corresponding a TCP port of the Android data processing system with a TCP port of the external display device.

In an embodiment of the application, the communication channel is implemented by a USB cable.

In an embodiment of the application, the communication channel is implemented by USB network share.

The application further provides an image mirror display device for an Android data processing system. The device includes: an image obtaining module, for executing a pre-stored virtual display screen record procedure by an Android Shell user privilege to obtain images displayed on a virtual display of the Android data processing system, wherein the images displayed on the virtual display are the same as current images displayed on an internal display of the Android data processing system; an image processing module, for processing and storing the images displayed on the virtual display of the Android data processing system; and an image transmission module, coupled to an external display device via a communication channel, for sending the stored images displayed on the virtual display of the Android data processing system to the external display device via the communication channel.

The application further provides an image mirror display device for an external display device. The device includes: an image receiving module, for receiving images displayed on a virtual display of an Android data processing system from the Android data processing system via a communication channel, wherein the external display device is coupled to the Android data processing system via the communication channel, and the images displayed on the virtual display are the same as images currently displayed on an internal display of the Android data processing system; and an image display module, for processing and displaying the received images displayed on the virtual display of the Android data processing system.

In the application, the Android Shell user privilege is allowed to execute the pre-stored virtual display screen record procedure for obtaining images displayed on the virtual display of the Android data processing system, wherein the images displayed on the virtual display are the same as the current images displayed on the internal display of the Android data processing system. In the application, the images displayed on the virtual display are processed and stored, the stored images displayed on the virtual display are sent to the external display device via a communication channel. Thus, by Android Shell user privilege, rather than by the root user privilege, the images displayed on the virtual display of the Android data processing system are recorded and sent to the external display device via a communication channel for image mirror displaying. In the application, the network bandwidth is not occupied, the operations are convenient and simple, and the delay in the image display procedure is prevented.

### BRIEF DESCRIPTION OF THE DRAWINGS

FIG. 1 shows a structure diagram for an Android data processing system according to an embodiment of the application.

FIG. 2 shows a flow chart for an image mirror display method according to an embodiment of the application.

FIG. 3 shows a pre-storage flow chart for a virtual display screen record procedure of an image mirror display method according to another embodiment of the application.

FIG. 4 shows a pre-storage flow chart for a virtual display screen record procedure of an image mirror display method according to yet another embodiment of the application.

FIG. 5 shows a pre-storage flow chart for a virtual display screen record procedure of an image mirror display method according to still another embodiment of the application.

FIG. 6 shows a structure diagram for an external display device according to an embodiment of the application.

FIG. 7 shows a flow chart for an image mirror display method according to another embodiment of the application.

FIG. 8 shows a structure diagram for an image display device according to an embodiment of the application.

FIG. 9 shows a structure diagram for a virtual display screen record device of an image display device according to another embodiment of the application.

FIG. 10 shows a structure diagram for a virtual display screen record device of an image display device according to yet another embodiment of the application.

FIG. 11 shows a structure diagram for a virtual display screen record device of an image display device according to still another embodiment of the application.

FIG. 12 shows a structure diagram for an image display device according to another embodiment of the application.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

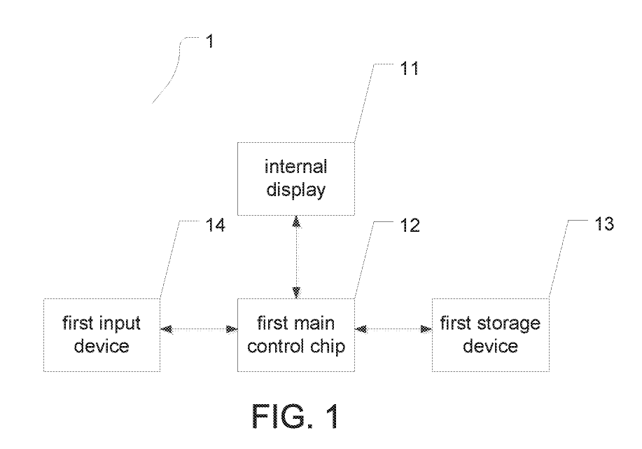

Refer to FIG. 1. An Android data processing system refers to an electronic device 1 having data processing functions, including for example but not limited by, an Android mobile phone, an Android computer, an Android PDA. The hardware of the electronic device 1 includes an internal display 11, a first main control chip 12, a first storage device 13 and a first input device 14. The first input device 14 is for receiving user input commands. The first storage device 13 is for storing applications and for accessing data. The internal display 11 is for displaying received or processed image data. The first main control chip 12 is for controlling operations of the functional devices.

In the Android data processing system, the first main control chip 12 executes applications stored in the first storage device 13 for data processing. User privileges of the Android data processing system include a regular user privilege and a root user privilege (system administrator) privilege. Only the root user privilege is allowed to record image data displayed on the screen of the Android data processing system. On the contrary, the regular user privilege is not allowed to record image data displayed on the screen of the Android data processing system. If for recording image data displayed on the screen, the Android data processing system changes the root system of the Android data processing system, then the security protection system of the Android data processing system may be damaged and thus the manufacture does not maintain the damaged Android data processing system.

In the application, the Android Shell user privilege is allowed to execute the pre-stored virtual display screen record procedure for obtaining images displayed on the virtual display of the Android data processing system, wherein the images displayed on the virtual display are the same as the current images displayed on the internal display of the Android data processing system. In the application, the images displayed on the virtual display are processed and stored, the stored images displayed on the virtual display are sent to the external display device via a communication channel. Thus, by Android Shell user privilege, rather than by the root user privilege, the images displayed on the virtual display of the Android data processing system are recorded and sent to the external display device via a communication channel for image mirror displaying. In the application, the network bandwidth is not occupied, the operations are convenient and simple, and the delay in the image display procedure is prevented.

Of course, any technical implementation of the application does not have to achieve all of the above advantages.

For the skilled person in the art to understand the technical implementations of the application, the technical implementations of the application are described clearly and entirely by referring to the accompanying drawings. However, the embodiments described in the application are just a part of embodiments of the application, not all embodiments of the application. After understanding the embodiments described in the application, other embodiments obtained by the skilled person in the art are within the scope and spirit of the application.

An embodiment of the application provides an image mirror display method used in an Android data processing system. Refer to FIG. 1. The Android data processing system refers to the electronic device 1 having data processing functions, including for example but not limited by, an Android mobile phone, an Android computer, an Android PDA. The electronic device 1 includes the internal display 11, the first main control chip 12, the first storage device 13 and the first input device 14.

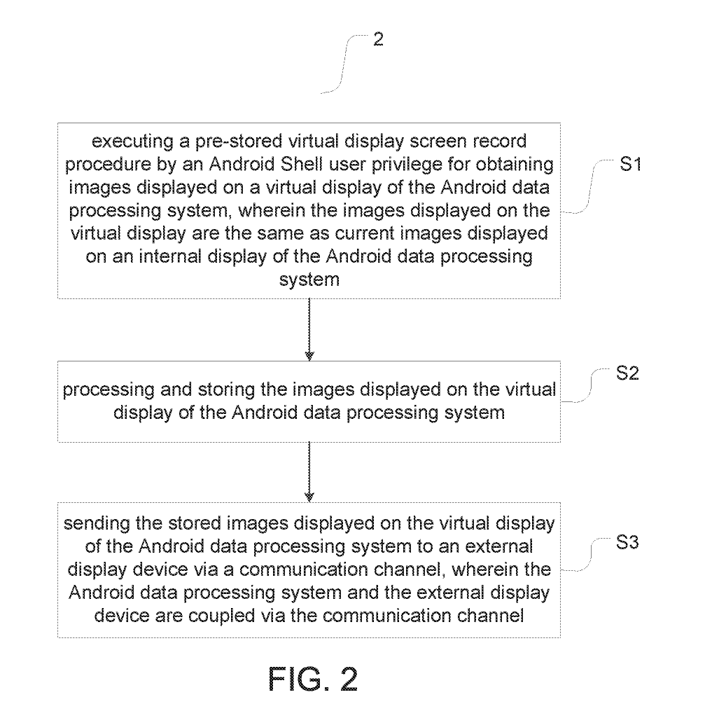

Refer to FIG. 2. An image mirror display method 2 includes steps S1-S3.

S1: the Android Shell user privilege executes the pre-stored virtual display screen record procedure for obtaining images displayed on the virtual display of the Android data processing system, wherein the images displayed on the virtual display are the same as the current images displayed on the internal display of the Android data processing system.

In implementation, Android system provides a “VirtualDisplay screenrecord” command line procedure. The “VirtualDisplay screenrecord” command line procedure is executed under Android adjustment bridge shell layer adb Shell for recording the images (which are the same as the images displayed on the internal display of the Android data processing system) displayed on the virtual display into a video file.

By using the “VirtualDisplay screenrecord” command line procedure, Android Shell user privilege is allowed to execute the pre-stored virtual display screen record procedure even without using the root user privilege. By this, the images displayed on the virtual display which are the same as the current images displayed on the internal display of the Android data processing system are obtained.

S2: The images displayed on the virtual display of the Android data processing system are processed and stored.

In the application, the images displayed on the virtual display of the Android data processing system which are obtained by executing the pre-stored virtual display screen record procedure by the Android Shell user privilege are processed and stored. Practically, the images displayed on the virtual display are stored in a first buffer space.

S3: the Android data processing system and the external display device are coupled via a communication channel, and the stored images displayed on the virtual display of the Android data processing system are sent to the external display device via a communication channel.

The images displayed on the virtual display of the Android data processing system are stored in the first buffer space and sent to the external display device for displaying via a communication channel. The external display device obtains the image mirrors of the images displayed on the internal display of the Android data processing system. Thus, the Android data processing system has improved display effect.

In the embodiment of the application, the Android Shell user privilege executes the pre-stored virtual display screen record procedure to obtain the images displayed on the virtual display of the Android data processing system. In the embodiment of the application, the images displayed on the virtual display are processed and stored, and the stored images displayed on the virtual display are sent to the external display device via a communication channel. Android Shell user privilege is allowed to record images displayed on the virtual display of the Android data processing system even without using the root user privilege, and the images displayed on the virtual display are sent to the external display device via a communication channel for image mirror display. In the application, the network bandwidth is not occupied, the operations are convenient and simple, and the delay in the image display procedure is prevented.

Another embodiment of the application provides an image mirror display method suitable for the Android data processing system. The method includes steps S1-S3.

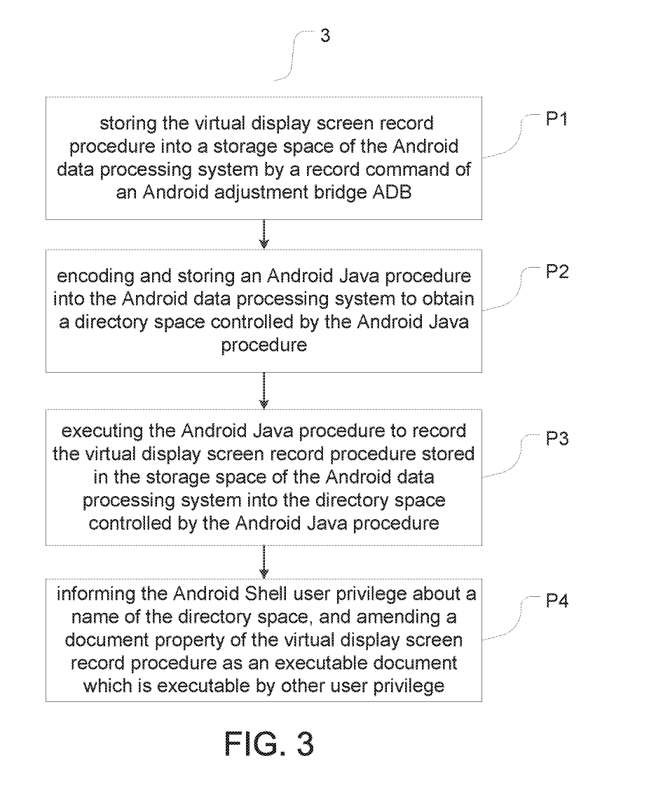

Practically, refer to FIG. 3. The pre-storage method 3 for the virtual display screen record procedure includes steps P1-P4.

P1: the virtual display screen record procedure is stored into the storage space of the Android data processing system by the record command of the Android adjustment bridge ADB.

Practically, the storage space of the Android data processing system is the SD card of the Android data processing system. The ADB record command is usually the adb push command or the adb Shell record command.

Because the Shell user privilege of the Android adjustment bridge ADB does not have the privilege to directly execute the virtual display screen record procedure on the SD card, there is a need to put the virtual display screen record procedure into a space where the Shell user privilege of the Android adjustment bridge ADB can execute the virtual display screen record procedure and to assign the Shell user privilege of the Android adjustment bridge ADB with a privilege to execute the virtual display screen record procedure.

Therefore, after the virtual display screen record procedure is stored into the SD card of the Android data processing system, steps P2-P4 are included.

P2: Android Java procedure are encoded and stored into the Android data processing system, to obtain the directory space controlled by the Android Java procedure.

Practically, the Android Java procedure is stored into the Android data processing system in the form of an Android application package apk. The Android system will establish a directory space for the Android Java procedure for execution and data storage of Android Java procedure. The directory space is controlled by the Android Java procedure.

P3: the Android Java procedure is executed to record the virtual display screen record procedure stored in the storage space of the Android data processing system into the directory space controlled by the Android Java procedure.

P4: The Android Shell user privilege is informed about the name of the directory space, and the document property of the virtual display screen record procedure is amended as an executable document which is executable by other user privilege.

In the application, the virtual display screen record procedure is placed into a space where the Shell user privilege of the Android adjustment bridge ADB can execute the virtual display screen record procedure, and the Shell user privilege of the Android adjustment bridge ADB is assigned with a privilege to execute the virtual display screen record procedure. In the application, the Shell user privilege of the Android adjustment bridge ADB can directly execute the virtual display screen record procedure stored in the SD card by executing the executable document in the Android Java procedure directory. Thus, the images displayed on the virtual display of the Android data processing system are obtained. “Other user privilege” refers to the regular Android Java procedure on the Java layer.

In practical implementation of the application, execution of the pre-stored virtual display screen record procedure by the Android Shell user privilege is achieved by executing the virtual display screen record procedure stored in the directory space via the adb Shell command input into the Android data processing system.

In the embodiment of the application, the Android Shell user privilege executes the pre-stored virtual display screen record procedure to obtain the images displayed on the virtual display of the Android data processing system. In the embodiment of the application, the images displayed on the virtual display are processed and stored, and the stored images displayed on the virtual display are sent to the external display device via the communication channel. Android Shell user privilege is allowed to record images displayed on virtual display of the Android data processing system even without using the root user privilege, and the images displayed on the virtual display are sent to the external display device via the communication channel for image mirror display. In the application, the network bandwidth is not occupied, the operations are convenient and simple, and the delay in the image display procedure is prevented.

Another embodiment of the application provides an image mirror display method suitable for the Android data processing system. The method includes steps S1-S3.

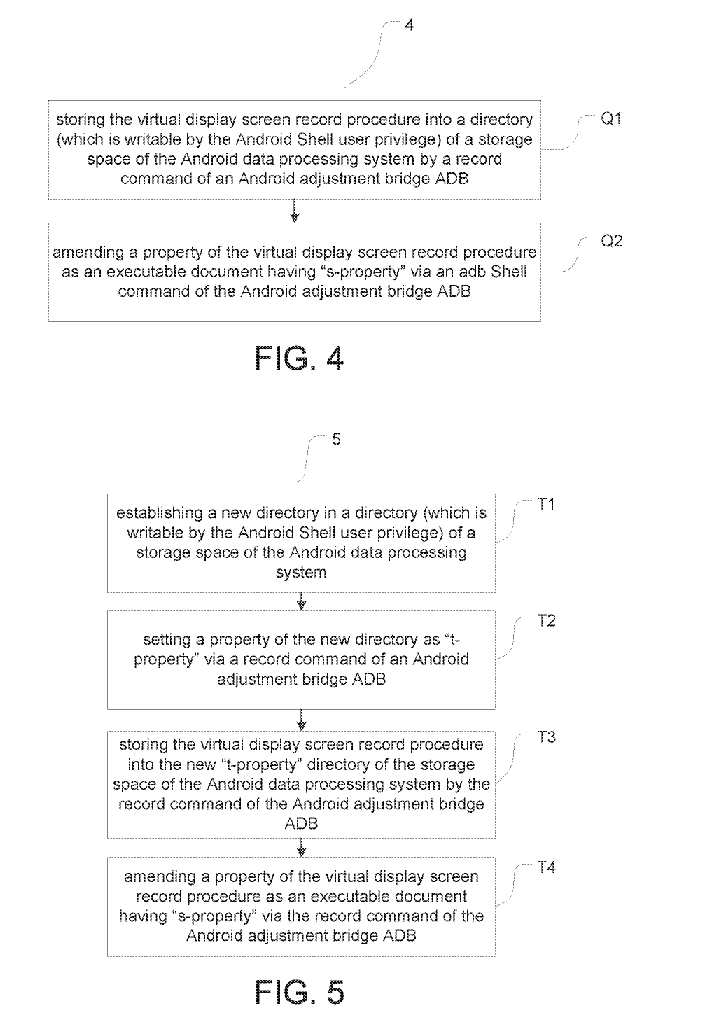

Practically, refer to FIG. 4. The pre-storage method 4 for the virtual display screen record procedure includes steps Q1-Q2.

Q1: the virtual display screen record procedure is stored into a directory (which is writable by the Shell user privilege) of the storage space of the Android data processing system by the record command of the Android adjustment bridge ADB.

The virtual display screen record procedure is stored into a directory (for example, /data/local/tmp, which is writable by the Shell user privilege) of the SD card of the Android data processing system. The ADB record command is usually the adb push command or the adb Shell record command.

Because the Shell user privilege of the Android adjustment bridge ADB does not have the privilege to directly execute the virtual display screen record procedure on the SD card, there is a need to put the virtual display screen record procedure into a space where the Shell user privilege of the Android adjustment bridge ADB can execute the virtual display screen record procedure and to assign the Shell user privilege of the Android adjustment bridge ADB with a privilege to execute the virtual display screen record procedure.

Therefore, after the virtual display screen record procedure is stored into the SD card of the Android data processing system, step Q2 is included.

Q2: the property of the procedure is amended as an executable document having “s-property” via the adb Shell command of the Android adjustment bridge ADB.

“s-property” refers to SetUID, which indicates an owner privilege of this document in execution of an executable procedure (or document). If an executable procedure has “s-property”, then the user privilege which executes the executable document has the Owner privilege on this executable document. After the property of the procedure is amended as “s-property” via the adb Shell command of the ADB record command, if other user privilege is used in executing the procedure, other user privilege still has the Shell privilege. “Other user privilege” refers to the regular Android Java procedure of the Java layer. That is, even if the regular Android Java procedure of the Java layer is used in executing the procedure, the Shell privilege is still assigned. Further, in the embodiment of the application the step of executing the pre-stored virtual display screen record procedure by the Android Shell user privilege is achieved by calling the virtual display screen record procedure by a procedure of an Android application package apk.

In the embodiment of the application, the virtual display screen record procedure is recorded into a location where the Shell user privilege of the Android adjustment bridge ADB can execute the virtual display screen record procedure; and the Shell user privilege of the Android adjustment bridge ADB is assigned with a privilege to execute the virtual display screen record procedure. In the embodiment of the application, the Shell user privilege of the Android adjustment bridge ADB can execute the executable document in the Android Java procedure directory to directly execute the virtual display screen record procedure on the SD card. Thus, the images displayed on the virtual display of the Android data processing system are obtained.

In the embodiment of the application, the Android Shell user privilege executes the pre-stored virtual display screen record procedure to obtain the images displayed on the virtual display of the Android data processing system. In the embodiment of the application, the images displayed on the virtual display are processed and stored, and the stored images displayed on the virtual display are sent to the external display device via a communication channel. Android Shell user privilege is allowed to record images displayed on the virtual display of the Android data processing system even without using the root user privilege, and the images displayed on the virtual display are sent to the external display device via a communication channel for image mirror display. In the application, the network bandwidth is not occupied, the operations are convenient and simple, and the delay in the image display procedure is prevented.

Another embodiment of the application provides an image mirror display method suitable for the Android data processing system. The method includes steps S1-S3.

Practically, refer to FIG. 5. The pre-storage method 5 for the virtual display screen record procedure includes steps T1-T4.

T1: a new directory is established in a directory (which is writable by the Shell user privilege) of the storage space of the Android data processing system.

The new directory is established in a directory (for example, /data/local/tmp, which is writable by the Shell user privilege) of the SD card of the Android data processing system.

T2: the property of the new directory is set as “t-property” via the record command of the Android adjustment bridge ADB.

The record command of the Android adjustment bridge ADB is usually the adb push command or the adb Shell record command.

“t-property” refers to a sticky bit. Usually, in Unix, in deleting a document, whether the user privilege owns the write privilege on the directory is considered. If the user privilege owns the write privilege on the directory, the user privilege is allowed to delete the document, without considering whether the user privilege is the owner of the document. For example, for a public shared directory, if there are a lot of user privileges who have write privilege on this directory, these user privileges also have deletion privilege on this directory. In the application, the new directory has “t-property” and thus, the owner of the document, or the owner of the directory or the root user privilege is allowed to delete the documents in this directory.

T3: the virtual display screen record procedure is stored into the new “t-property” directory of the storage space of the Android data processing system by the record command of the Android adjustment bridge ADB.

After the virtual display screen record procedure is stored into the new “t-property” directory of the storage space of the Android data processing system by the record command, other user privileges cannot delete the virtual display screen record procedure.

Because the Shell user privilege of the Android adjustment bridge ADB does not have the privilege to directly execute the virtual display screen record procedure on the SD card, there is a need to put the virtual display screen record procedure into a space where the Shell user privilege of the Android adjustment bridge ADB can execute the virtual display screen record procedure and to assign the Shell user privilege of the Android adjustment bridge ADB with a privilege to execute the virtual display screen record procedure.

Therefore, after the virtual display screen record procedure is stored into the SD card of the Android data processing system, step T4 is included.

T4: the property of the procedure is amended as an executable document having “s-property” via the adb Shell command of the Android adjustment bridge ADB.

“s-property” refers to SetUID, which indicates an owner privilege of this document in execution of an executable procedure (or document). If an executable procedure has “s-property”, then the user privilege which executes the executable document has the Owner privilege on this executable document. After the property of the procedure is amended as “s-property” via the adb Shell command of the ADB record command, if other user privilege is used in executing the procedure, other user privilege still has the Shell privilege. “Other user privilege” refers to the regular Android Java procedure of the Java layer. That is, even if the regular Android Java procedure of the Java layer is used in executing the procedure, the Shell privilege is still assigned.

In the embodiment of the application, the virtual display screen record procedure is recorded into a location where the Shell user privilege of the Android adjustment bridge ADB can execute the virtual display screen record procedure; and the Shell user privilege of the Android adjustment bridge ADB is assigned with a privilege to execute the virtual display screen record procedure. In the embodiment of the application, the Shell user privilege of the Android adjustment bridge ADB can execute the executable documents in the Android Java procedure directory to directly execute the virtual display screen record procedure on the SD card. Thus, the images displayed on the virtual display of the Android data processing system are obtained.

In the embodiment of the application, the Android Shell user privilege executes the pre-stored virtual display screen record procedure to obtain the images displayed on the virtual display of the Android data processing system. In the embodiment of the application, the images displayed on the virtual display are processed and stored, and the stored images displayed on the virtual display are sent to the external display device via the communication channel. Android Shell user privilege is allowed to record images displayed on virtual display of the Android data processing system even without using the root user privilege, and the images displayed on the virtual display are sent to the external display device via the communication channel for image mirror display. In the application, the network bandwidth is not occupied, the operations are convenient and simple, and the delay in the image display procedure is prevented.

Another embodiment of the application provides an image mirror display method suitable for the Android data processing system. The method includes the following steps.

S1: the Android Shell user privilege executes the pre-stored virtual display screen record procedure for obtaining images displayed on the virtual display of the Android data processing system, wherein the images displayed on the virtual display are the same as the current images displayed on the internal display of the Android data processing system.

S2: The images displayed on the virtual display of the Android data processing system are processed and stored.

Because H.264 has highest compression rate among the current compression algorithms, the step of processing and storage of the images displayed on the virtual display of the Android data processing system is to compress the images displayed on the virtual display of the Android data processing system into a video stream flow compatible with H.264 standard. This is helpful in reducing data transmission bandwidth.

Practically, because “stage fright” is the multimedia frame structure used by Android, which packs the encoding-decoding hardware together. Thus, different hardware shares the same API. In the embodiment of the application, the multimedia frame structure processing flow “Stagefright” of Android is used to process the currently displayed virtual images on the internal display.

Because the hardware encoder has low cost and short encoding time, in the embodiment of the application, the hardware encoder is used to compress the currently displayed virtual images on the internal display into a video stream flow compatible with H.264 standard.

S3: the Android data processing system and the external display device are coupled via the communication channel, the stored images displayed on the virtual display of the Android data processing system are sent to the external display device via the communication channel.

The images displayed on the virtual display of the Android data processing system are stored in the first buffer space and sent to the external display device via the communication channel for displaying. The external display device obtains the mirrored images by mirroring the images displayed on the internal display of the Android data processing system. Thus, the Android data processing system has improved display effect.

In the embodiment of the application, the Android Shell user privilege executes the pre-stored virtual display screen record procedure to obtain the images displayed on the virtual display of the Android data processing system. In the embodiment of the application, the images displayed on the virtual display are processed and stored, and the stored images displayed on the virtual display are sent to the external display device via the communication channel. Android Shell user privilege is allowed to record images displayed on the virtual display of the Android data processing system even without using the root user privilege, and the images displayed on the virtual display are sent to the external display device via the communication channel for image mirror display. In the application, the network bandwidth is not occupied, the operations are convenient and simple, and the delay in the image display procedure is prevented.

Another embodiment of the application provides an image mirror display method suitable for the Android data processing system. The method includes the following steps.

S1: the Android Shell user privilege executes the pre-stored virtual display screen record procedure for obtaining images displayed on the virtual display of the Android data processing system, wherein the images displayed on the virtual display are the same as the current images displayed on the internal display of the Android data processing system.

S2: The images displayed on the virtual display of the Android data processing system are processed and stored.

S3: the Android data processing system and the external display device are coupled via the communication channel, and the stored images displayed on the virtual display of the Android data processing system are sent to the external display device via the communication channel.

The Android adjustment bridge ADB may correspond the TCP port of the Android data processing system with the TCP port of the external display device (for example, an on-board unit) which is connected via USB. For example, the command “adb forward tcp:100 tcp:200” corresponds the TCP port 200 of the Android data processing system with the TCP port 100 of the external display device (for example, an on-board unit) which executes the Android adjustment bridge. Thus, the Android data processing system opens the socket for TCP port 200 and the external display device (for example, an on-board unit) opens the socket for TCP port 100. The Android data processing system and the external display device may communicate with each other.

Thus, the communication channel is implemented by corresponding the TCP port of Android data processing system and the TCP port of the external display device. Practically, the communication channel is a USB cable.

In the embodiment of the application, the image data transmission between the Android data processing system and the external display device may be achieved even without WiFi wireless network or any wired network. The embodiment of the application is suitable in the environment where wireless data transmission is not available, for example, in the flying airplane or in the situation that a car drives into an area having poor wireless signal strength. Thus, the image data transmission between the Android data processing system and the external display device has wider application field. Further, in the embodiment of the application, the image data transmission between the Android data processing system and the external display device does not occupy the network bandwidth, the operations are convenient and simple, and the delay in the image display procedure is prevented.

In the embodiment of the application, the Android Shell user privilege executes the pre-stored virtual display screen record procedure to obtain the images displayed on the virtual display of the Android data processing system. In the embodiment of the application, the images displayed on the virtual display are processed and stored, and the stored images displayed on the virtual display are sent to the external display device via the communication channel. Android Shell user privilege is allowed to record images displayed on virtual display of the Android data processing system even without using the root user privilege, and the images displayed on the virtual display are sent to the external display device via the communication channel for image mirror display. In the application, the network bandwidth is not occupied, the operations are convenient and simple, and the delay in the image display procedure is prevented.

Another embodiment of the application provides an image mirror display method suitable for the Android data processing system. The method includes steps S1-S3.

Practically, the communication channel is implemented by USB network share.

In the embodiment of the application, the image data transmission between the Android data processing system and the external display device may be achieved even without WiFi wireless network or any wired network. The embodiment of the application is suitable in the environment where wireless data transmission is not available, for example, in the flying airplane or in the situation that a car drives into an area having poor wireless signal strength. Thus, the image data transmission between the Android data processing system and the external display device has wider application field. Further, in the embodiment of the application, the image data transmission between the Android data processing system and the external display device does not occupy the network bandwidth, the operations are convenient and simple, and the delay in the image display procedure is prevented.

In the embodiment of the application, the Android Shell user privilege executes the pre-stored virtual display screen record procedure to obtain the images displayed on the virtual display of the Android data processing system. In the embodiment of the application, the images displayed on the virtual display are processed and stored, and the stored images displayed on the virtual display are sent to the external display device via the communication channel. Android Shell user privilege is allowed to record images displayed on the virtual display of the Android data processing system even without using the root user privilege, and the images displayed on the virtual display are sent to the external display device via the communication channel for image mirror display. In the application, the network bandwidth is not occupied, the operations are convenient and simple, and the delay in the image display procedure is prevented.

Another embodiment of the application provides an image mirror display method suitable for the Android data processing system. The method includes steps S1-S3.

Practically, the property of the SELinux context of the virtual display screen record procedure is amended by commands, and thus the virtual display screen record procedure is executed by the Android Shell user privilege.

SELinux is a Role-Based Access Control (RBAC) Linux promoted by NSA of US. In Linux, the safety regulation in the conventional UNIX privilege should be also compatible with the safety regulation in SELinux, and thus the privilege verification is passed. In practical implementation of the application, the property of the SELinux context of the virtual display screen record procedure is amended by a “chcon” command. In the application, the property of the SELinux context of the virtual display screen record procedure is amended as “u:object_r:system_file:s0” by the “chcon” command, and thus the virtual display screen record procedure is executed by the Android Shell user privilege.

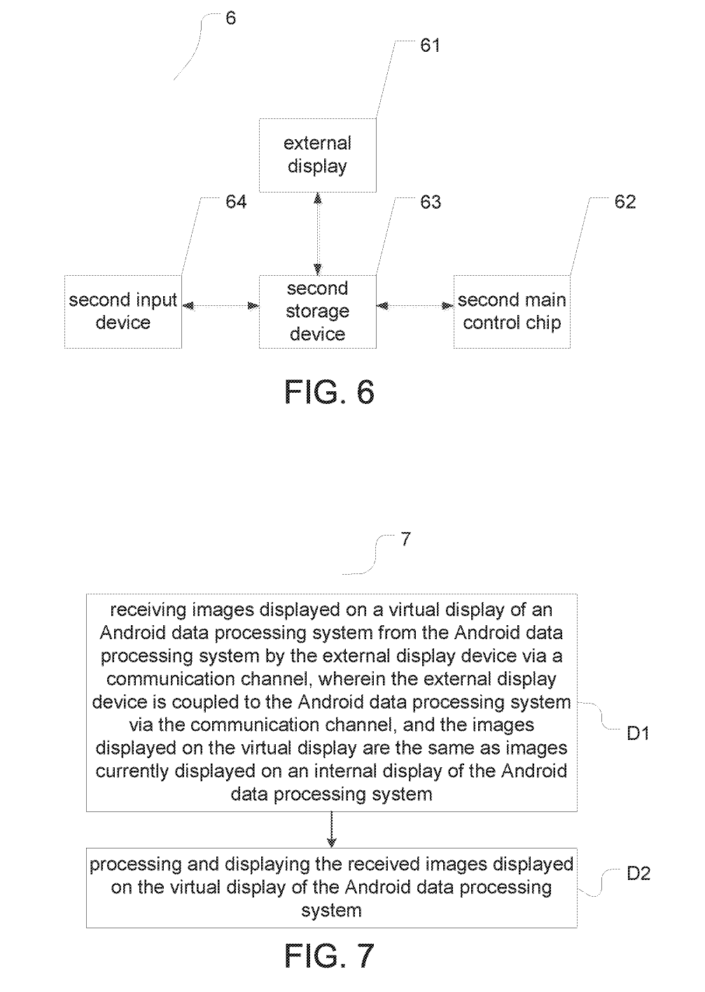

Another embodiment of the application provides an image mirror display method suitable for the Android data processing system. Refer to FIG. 6. The external display device includes an electronic device 6 (for example, an on-board unit) and having an external display. The hardware of the external display device include: an external display 61, a second main control chip 62, a second storage device 63 and a second input device 64.

Refer to FIG. 7. The method includes the following steps D1-D2.

D1: the external display device is coupled to the Android data processing system via a communication channel and receives the images displayed on the virtual display of the Android data processing system from the Android data processing system via a communication channel. The images displayed on the virtual display are the same as the images currently displayed on the internal display of the Android data processing system.

The Android adjustment bridge ADB may correspond the TCP port of the Android data processing system with the TCP port of the external display device (for example, an on-board unit) which is connected via USB. For example, the command “adb forward tcp:100 tcp:200” corresponds the TCP port 200 of the Android data processing system with the TCP port 100 of the external display device (for example, an on-board unit) which executes the Android adjustment bridge. Thus, the Android data processing system opens the socket for TCP port 200 and the external display device (for example, an on-board unit) opens the socket for TCP port 100. The Android data processing system and the external display device may communicate with each other.

Thus, the communication channel is implemented by corresponding the TCP port of Android data processing system and the TCP port of the external display device. Practically, the communication channel is a USB cable.

Besides, the communication channel in the application may be implemented by the USB network share.

In the embodiment of the application, the image data transmission between the Android data processing system and the external display device may be achieved even without WiFi wireless network or any wired network. The embodiment of the application is suitable in the environment where wireless data transmission is not available, for example, in the flying airplane or in the situation that a car drives into an area having poor wireless signal strength. Thus, the image data transmission between the Android data processing system and the external display device has wider application field. Further, in the embodiment of the application, the image data transmission between the Android data processing system and the external display device does not occupy the network bandwidth, the operations are convenient and simple, and the delay in the image display procedure is prevented.

D2: the received images displayed on the virtual display of the Android data processing system are processed and displayed.

In the embodiment of the application, the external display device is coupled to the Android data processing system via a communication channel and receives the images displayed on the virtual display of the Android data processing system from the Android data processing system via a communication channel. The received images displayed on the virtual display of the Android data processing system are processed and displayed. Thus, the images displayed on the virtual display are sent to the external display device for image mirror display via the communication channel. In the application, the network bandwidth is not occupied, the operations are convenient and simple, and the delay in the image display procedure is prevented.

Accompanied with the above methods, an embodiment of the application provides an image mirror display device applied in an Android data processing system. Refer to FIG. 1. The Android data processing system includes the electronic device 1 having data processing functions, including for example but not limited by, an Android mobile phone, an Android computer, an Android PDA. The hardware of the electronic device 1 includes the internal display 11, the first main control chip 12, the first storage device 13 and the first input device 14.

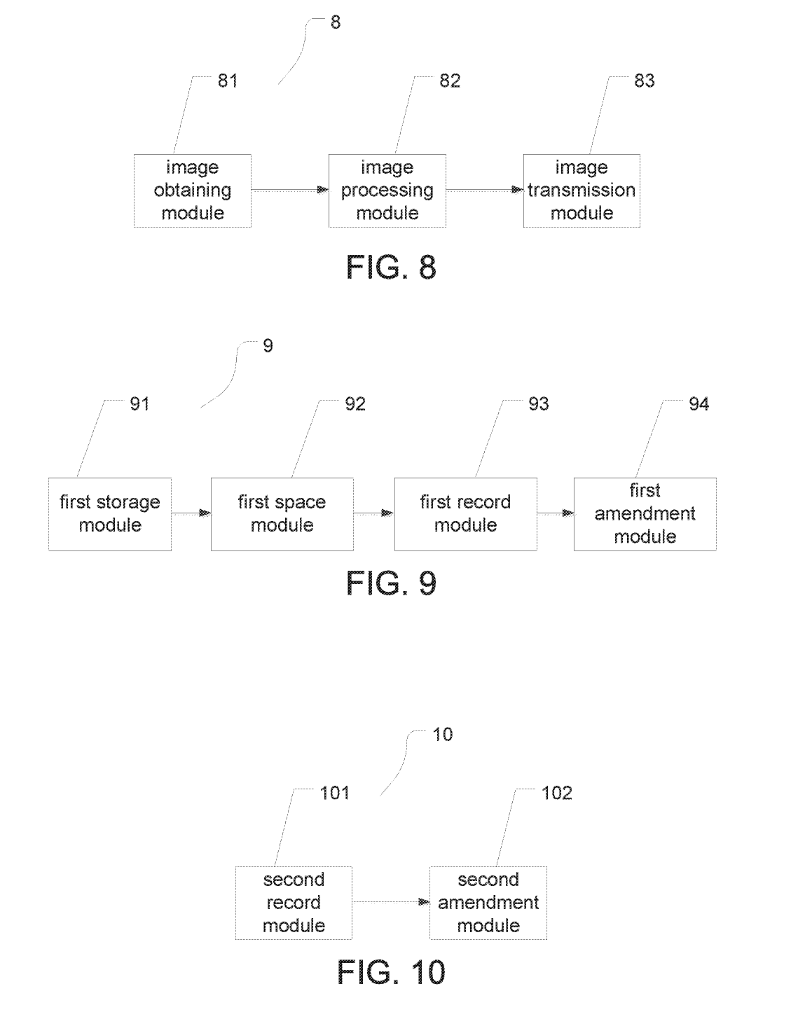

Refer to FIG. 8. The image mirror display device includes: an image obtaining module 81, an image processing module 82 and an image transmission module 83.

The image obtaining module 81 obtains images displayed on the virtual display of the Android data processing system via executing the pre-stored virtual display screen record procedure by the Android Shell user privilege. The images displayed on the virtual display are the same as the current images displayed on the internal display of the Android data processing system.

In implementation, Android system provides a “VirtualDisplay screenrecord” command line procedure. The “VirtualDisplay screenrecord” command line procedure is executed under Android adjustment bridge shell layer adb Shell for recording the images (which are the same as the images displayed on the internal display of the Android data processing system) displayed on the virtual display into a video file.

In the application, by using the “VirtualDisplay screenrecord” command line procedure, Android Shell user privilege is allowed to execute the pre-stored virtual display screen record procedure even without using the root user privilege. By this, the images displayed on the virtual display which are the same as the current images displayed on the internal display of the Android data processing system are obtained.

The image processing module 82 is for processing and storing the images displayed on the virtual display of the Android data processing system.

In the application, the images displayed on the virtual display of the Android data processing system which are obtained by executing the pre-stored virtual display screen record procedure by the Android Shell user privilege are processed and stored. Practically, the images displayed on the virtual display are stored in a first buffer space.

The image transmission module 83 is for coupling with the external display device via a communication channel and for sending the stored images displayed on the virtual display of the Android data processing system to the external display device via the communication channel.

The images displayed on the virtual display of the Android data processing system are stored in the first buffer space and sent to the external display device via a communication channel for displaying. The external display device obtains the image mirrors of the images displayed on the internal display of the Android data processing system. Thus, the Android data processing system has improved display effect.

In the embodiment of the application, the Android Shell user privilege executes the pre-stored virtual display screen record procedure to obtain the images displayed on the virtual display of the Android data processing system. In the embodiment of the application, the images displayed on the virtual display are processed and stored, and the stored images displayed on the virtual display are sent to the external display device via a communication channel. Android Shell user privilege is allowed to record images displayed on virtual display of the Android data processing system even without using the root user privilege, and the images displayed on the virtual display are sent to the external display device via a communication channel for image mirror display. In the application, the network bandwidth is not occupied, the operations are convenient and simple, and the delay in the image display procedure is prevented.

Another embodiment of the application provides an image mirror display device for an Android data processing system. The image mirror display device includes: the image obtaining module 81, the image processing module 82 and the image transmission module 83.

Practically, refer to FIG. 9. The pre-storage device 9 for the virtual display screen record procedure includes: a first storage module 91, a first space module 92, a first record module 93 and a first amendment module 94.

The first storage module 91 stores the virtual display screen record procedure into the storage space of the Android data processing system by the record command of the Android adjustment bridge ADB.

Practically, the storage space of the Android data processing system is the SD card of the Android data processing system. The ADB record command is usually the adb push command or the adb Shell record command.

Because the Shell user privilege of the Android adjustment bridge ADB does not have the privilege to directly execute the virtual display screen record procedure on the SD card, there is a need to put the virtual display screen record procedure into a space where the Shell user privilege of the Android adjustment bridge ADB can execute the virtual display screen record procedure and to assign the Shell user privilege of the Android adjustment bridge ADB with a privilege to execute the virtual display screen record procedure.

The first space module 92 is for encoding and storing Android Java procedure into the Android data processing system to obtain the directory space controlled by the Android Java procedure.

Practically, the Android Java procedure is stored into the Android data processing system in the form of an Android application package apk. The Android system will establish a directory space for the Android Java procedure for execution and data storage of Android Java procedure. The directory space is controlled by the Android Java procedure.

The first record module 93 is for executing the Android Java procedure to record the virtual display screen record procedure stored in the storage space of the Android data processing system into the directory space controlled by the Android Java procedure.

The first amendment module 94 is for informing the Android Shell user privilege about the name of the directory space and for amending the document property of the virtual display screen record procedure as an executable document which is executable by other user privilege.

In the application, the virtual display screen record procedure is placed into a space where the Shell user privilege of the Android adjustment bridge ADB can execute the virtual display screen record procedure, and the Shell user privilege of the Android adjustment bridge ADB is assigned with a privilege to execute the virtual display screen record procedure. In the application, the Shell user privilege of the Android adjustment bridge ADB can directly execute the virtual display screen record procedure stored in the SD card by executing the executable document in the Android Java procedure directory. Thus, the images displayed on the virtual display of the Android data processing system are obtained. “Other user privilege” refers to the regular Android Java procedure on the Java layer.

In practical implementation of the application, execution of the pre-stored virtual display screen record procedure by the Android Shell user privilege is achieved by executing the virtual display screen record procedure stored in the directory space via the adb Shell command input into the Android data processing system.

In the embodiment of the application, the Android Shell user privilege executes the pre-stored virtual display screen record procedure to obtain the images displayed on the virtual display of the Android data processing system. In the embodiment of the application, the images displayed on the virtual display are processed and stored, and the stored images displayed on the virtual display are sent to the external display device via a communication channel. Android Shell user privilege is allowed to record images displayed on virtual display of the Android data processing system even without using the root user privilege, and the images displayed on the virtual display are sent to the external display device via a communication channel for image mirror display. In the application, the network bandwidth is not occupied, the operations are convenient and simple, and the delay in the image display procedure is prevented.

Another embodiment of the application provides an image mirror display device for an Android data processing system. The image mirror display device includes: the image obtaining module 81, the image processing module 82 and the image transmission module 83.

Practically, refer to FIG. 10. The pre-storage device 10 for the virtual display screen record procedure includes: a second record module 101 and a second amendment module 102.

The second record module 101 is for storing the virtual display screen record procedure into a directory (which is writable by the Shell user privilege) of the storage space of the Android data processing system by the record commands of the Android adjustment bridge ADB.

The virtual display screen record procedure is stored into a directory (for example, /data/local/tmp, which is writable by the Shell user privilege) of the SD card of the Android data processing system. The ADB record command is usually the adb push command or the adb Shell record commands.

Because the Shell user privilege of the Android adjustment bridge ADB does not have the privilege to directly execute the virtual display screen record procedure on the SD card, there is a need to put the virtual display screen record procedure into a space where the Shell user privilege of the Android adjustment bridge ADB can execute the virtual display screen record procedure and to assign the Shell user privilege of the Android adjustment bridge ADB with a privilege to execute the virtual display screen record procedure.

The second amendment module 102 is for amending the property of the procedure as an executable document having “s-property” via the adb Shell command of the Android adjustment bridge ADB.

“s-property” refers to SetUID, which indicates an owner privilege of this document in execution of an executable procedure (or document). If an executable procedure has “s-property”, then the user privilege which executes the executable document has the Owner privilege on this executable document. After the property of the procedure is amended as “s-property” via the adb Shell command of the ADB record command, if other user privilege is used in executing the procedure, other user privilege still has the Shell privilege. “Other user privilege” refers to the regular Android Java procedure of the Java layer. That is, even if the regular Android Java procedure of the Java layer is used in executing the procedure, the Shell privilege is still assigned.

In the embodiment of the application, the virtual display screen record procedure is recorded into a location where the Shell user privilege of the Android adjustment bridge ADB can execute the virtual display screen record procedure; and the Shell user privilege of the Android adjustment bridge ADB is assigned with a privilege to execute the virtual display screen record procedure. In the embodiment of the application, the Shell user privilege of the Android adjustment bridge ADB can execute the executable documents in the Android Java procedure directory to directly execute the virtual display screen record procedure on the SD card. Thus, the images displayed on the virtual display of the Android data processing system are obtained.

In the embodiment of the application, the Android Shell user privilege executes the pre-stored virtual display screen record procedure to obtain the images displayed on the virtual display of the Android data processing system. In the embodiment of the application, the images displayed on the virtual display are processed and stored, and the stored images displayed on the virtual display are sent to the external display device via a communication channel. Android Shell user privilege is allowed to record images displayed on virtual display of the Android data processing system even without using the root user privilege, and the images displayed on the virtual display are sent to the external display device via a communication channel for image mirror display. In the application, the network bandwidth is not occupied, the operations are convenient and simple, and the delay in the image display procedure is prevented.

Another embodiment of the application provides an image mirror display device suitable for the Android data processing system. The image mirror display device includes the image obtaining module 81, the image processing module 82 and the image transmission module 83.

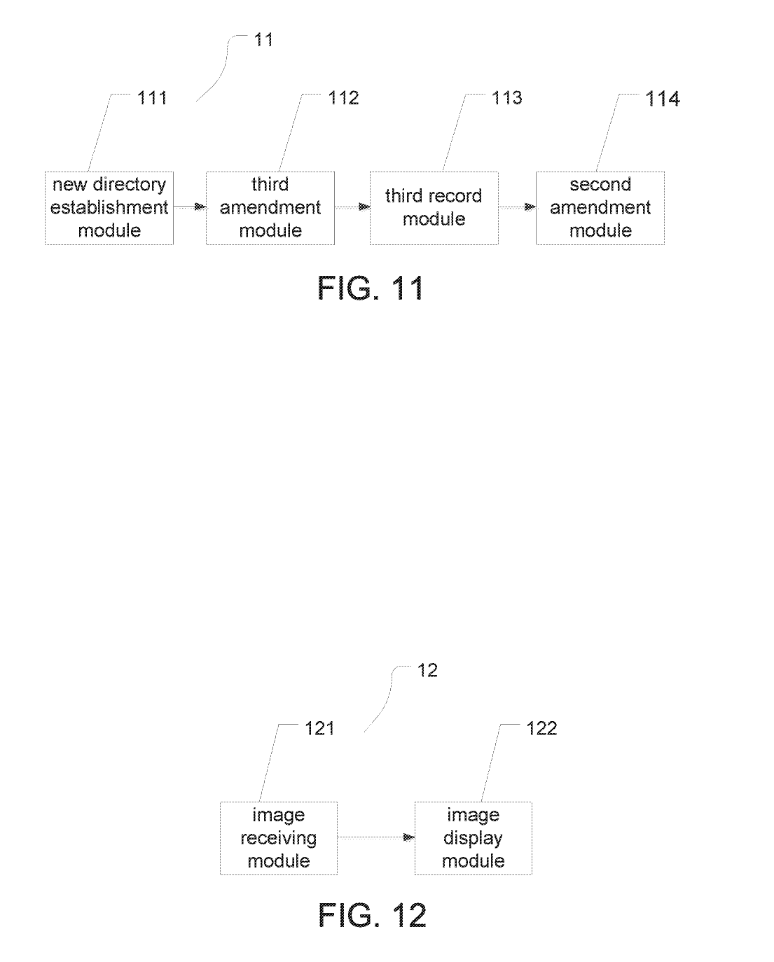

Practically, refer to FIG. 11. The pre-storage device 11 for the virtual display screen record procedure includes: a new directory establishment module 111, a third amendment module 112, a third record module 113 and the second amendment module 114.

The new directory establishment module 111 is for establishing a new directory in a directory (which is writable by the Shell user privilege) of the storage space of the Android data processing system.

The new directory is established in a directory (for example, /data/local/tmp, which is writable by the Shell user privilege) of the SD card of the Android data processing system.

The third amendment module 112 is for setting the property of the new directory as “t-property” via the record commands of the Android adjustment bridge ADB.

The record command of the Android adjustment bridge ADB is usually the adb push command or the adb Shell record command.

“t-property” refers to a sticky bit. Usually, in Unix, in deleting a document, whether the user privilege owns the write privilege on the directory is considered. If the user privilege owns the write privilege on the directory, the user privilege is allowed to delete the document, without considering whether the user privilege is the owner of the document. For example, for a public shared directory, if there are a lot of user privileges who have write privilege on this directory, then these user privileges also have deletion privilege on this directory. In the application, the new directory has “t-property” and thus, the owner of the document, or the owner of the directory or the root user privilege is allowed to delete the documents in this directory.

The third record module 113 is for storing the virtual display screen record procedure into the new “t-property” directory of the storage space of the Android data processing system by the record command of the Android adjustment bridge ADB.

After the virtual display screen record procedure is stored into the new “t-property” directory the storage space of the Android data processing system by the record command, other user privileges cannot delete the virtual display screen record procedure.

Because the Shell user privilege of the Android adjustment bridge ADB does not have the privilege to directly execute the virtual display screen record procedure on the SD card, there is a need to put the virtual display screen record procedure into a space where the Shell user privilege of the Android adjustment bridge ADB can execute the virtual display screen record procedure and to assign the Shell user privilege of the Android adjustment bridge ADB with a privilege to execute the virtual display screen record procedure.

The second amendment module 114 is for amending the property of the procedure as an executable document having “s-property” via the adb Shell command of the Android adjustment bridge ADB.

“s-property” refers to SetUID, which indicates an owner privilege of this document in execution of an executable procedure (or document). If an executable procedure has “s-property”, then the user privilege which executes the executable document has the Owner privilege on this executable document. After the property of the procedure is amended as “s-property” via the adb Shell command of the ADB record commands, if other user privilege is used in executing the procedure, other user privilege still has the Shell privilege. “Other user privilege” refers to the regular Android Java procedure of the Java layer. That is, even if the regular Android Java procedure of the Java layer is used in executing the procedure, the Shell privilege is still assigned.

In the embodiment of the application, the virtual display screen record procedure is recorded into a location where the Shell user privilege of the Android adjustment bridge ADB can execute the virtual display screen record procedure; and the Shell user privilege of the Android adjustment bridge ADB is assigned with a privilege to execute the virtual display screen record procedure. In the embodiment of the application, the Shell user privilege of the Android adjustment bridge ADB can execute the executable documents in the Android Java procedure directory to directly execute the virtual display screen record procedure on the SD card. Thus, the images displayed on the virtual display of the Android data processing system are obtained.

In the embodiment of the application, the Android Shell user privilege executes the pre-stored virtual display screen record procedure to obtain the images displayed on the virtual display of the Android data processing system. In the embodiment of the application, the images displayed on the virtual display are processed and stored, and the stored images displayed on the virtual display are sent to the external display device via a communication channel. Android Shell user privilege is allowed to record images displayed on virtual display of the Android data processing system even without using the root user privilege, and the images displayed on the virtual display are sent to the external display device via a communication channel for image mirror display. In the application, the network bandwidth is not occupied, the operations are convenient and simple, and the delay in the image display procedure is prevented.

Another embodiment of the application provides an image mirror display device suitable for the Android data processing system. The image mirror display device includes the image obtaining module 81, the image processing module 82 and the image transmission module 83.

Because H.264 has highest compression rate among the current compression algorithms, processing and storage of the images displayed on the virtual display of the Android data processing system is to compress the images displayed on the virtual display of the Android data processing system into a video stream flow compatible with H.264 standard. This is helpful in reducing bandwidth used in data transmission.

Practically, because “stage fright” is the multimedia frame structure used by Android, which packs the encoding-decoding hardware together. Thus, different hardware shares the same API. In the embodiment of the application, the multimedia frame structure processing flow “Stagefright” of Android is used to process the currently displayed virtual images on the internal display.

Because the hardware encoder has low cost and short encoding time, in the embodiment of the application, the hardware encoder is used to compress the currently displayed virtual images on the internal display into video stream flow compatible with H.264 standard.

In the embodiment of the application, the Android Shell user privilege executes the pre-stored virtual display screen record procedure to obtain the images displayed on the virtual display of the Android data processing system. In the embodiment of the application, the images displayed on the virtual display are processed and stored, and the stored images displayed on the virtual display are sent to the external display device via a communication channel. Android Shell user privilege is allowed to record images displayed on virtual display of the Android data processing system even without using the root user privilege, and the images displayed on the virtual display are sent to the external display device via a communication channel for image mirror display. In the application, the network bandwidth is not occupied, the operations are convenient and simple, and the delay in the image display procedure is prevented.

Another embodiment of the application provides an image mirror display device suitable for the Android data processing system. The image mirror display device includes the image obtaining module 81, the image processing module 82 and the image transmission module 83.

The Android adjustment bridge ADB may correspond the TCP port of the Android data processing system with the TCP port of the external display device (for example, an on-board unit) which is connected via USB. For example, the command “adb forward tcp:100 tcp:200” corresponds the TCP port 200 of the Android data processing system with the TCP port 100 of the external display device (for example, an on-board unit) which executes the Android adjustment bridge. Thus, the Android data processing system opens the socket for TCP port 200 and the external display device (for example, an on-board unit) opens the socket for TCP port 100. The Android data processing system and the external display device may communicate with each other.

Thus, the communication channel is implemented by corresponding the TCP port of Android data processing system and the TCP port of the external display device. Practically, the communication channel is a USB cable.

In the embodiment of the application, the image data transmission between the Android data processing system and the external display device may be achieved even without WiFi wireless network or any wired network. The embodiment of the application is suitable in the environment where wireless data transmission is not available, for example, in the flying airplane or in the situation that a car drives into an area having poor wireless signal strength. Thus, the image data transmission between the Android data processing system and the external display device has wider application field. Further, in the embodiment of the application, the image data transmission between the Android data processing system and the external display device does not occupy the network bandwidth, the operations are convenient and simple, and the delay in the image display procedure is prevented.

In the embodiment of the application, the Android Shell user privilege executes the pre-stored virtual display screen record procedure to obtain the images displayed on the virtual display of the Android data processing system. In the embodiment of the application, the images displayed on the virtual display are processed and stored, and the stored images displayed on the virtual display are sent to the external display device via a communication channel. Android Shell user privilege is allowed to record images displayed on virtual display of the Android data processing system even without using the root user privilege, and the images displayed on the virtual display are sent to the external display device via a communication channel for image mirror display. In the application, the network bandwidth is not occupied, the operations are convenient and simple, and the delay in the image display procedure is prevented.

Another embodiment of the application provides an image mirror display device suitable for the Android data processing system. The image mirror display device includes the image obtaining module 81, the image processing module 82 and the image transmission module 83.

Practically, the communication channel is implemented by USB network share.

In the embodiment of the application, the image data transmission between the Android data processing system and the external display device may be achieved even without WiFi wireless network or any wired network. The embodiment of the application is suitable in the environment where wireless data transmission is not available, for example, in the flying airplane or in the situation that a car drives into an area having poor wireless signal strength. Thus, the image data transmission between the Android data processing system and the external display device has wider application field. Further, in the embodiment of the application, the image data transmission between the Android data processing system and the external display device does not occupy the network bandwidth, the operations are convenient and simple, and the delay in the image display procedure is prevented.

In the embodiment of the application, the Android Shell user privilege executes the pre-stored virtual display screen record procedure to obtain the images displayed on the virtual display of the Android data processing system. In the embodiment of the application, the images displayed on the virtual display are processed and stored, and the stored images displayed on the virtual display are sent to the external display device via a communication channel. Android Shell user privilege is allowed to record images displayed on virtual display of the Android data processing system even without using the root user privilege, and the images displayed on the virtual display are sent to the external display device via a communication channel for image mirror display. In the application, the network bandwidth is not occupied, the operations are convenient and simple, and the delay in the image display procedure is prevented.

Another embodiment of the application provides an image mirror display device suitable for the Android data processing system. The image mirror display device includes the image obtaining module 81, the image processing module 82 and the image transmission module 83.

Practically, the property of the SELinux context of the virtual display screen record procedure is amended by commands, and thus the virtual display screen record procedure is executed by the Android Shell user privilege.

SELinux is a Role-Based Access Control (RBAC) Linux promoted by NSA of US. In Linux, the safety regulation in the conventional UNIX privilege should be also compatible with the safety regulation in SELinux, and thus the privilege verification is passed. In practical implementation of the application, the property of the SELinux context of the virtual display screen record procedure is amended by “chcon” commands. In the application, the property of the SELinux context of the virtual display screen record procedure is amended as “u:object_r:system_file:s0” by the “chcon” command, and thus the virtual display screen record procedure is executed by the Android Shell user privilege.

Another embodiment of the application provides an image mirror display method suitable for the Android data processing system. Refer to FIG. 6. The external display device includes an electronic device 6 installing with an on-board unit and having an external display. The hardware of the external display device include: an external display 61, a second main control chip 62, a second storage device 63 and a second input device 64.

Refer to FIG. 12. The device 12 includes: an image receiving module 121 and an image display module 122.

The image receiving module 121 is for coupling to the Android data processing system via a communication channel and for receiving the images displayed on the virtual display of the Android data processing system from the Android data processing system via the communication channel. The images displayed on the virtual display are the same as the images currently displayed on the internal display of the Android data processing system.

The Android adjustment bridge ADB may correspond the TCP port of the Android data processing system with the TCP port of the external display device (for example, an on-board unit) which is connected via USB. For example, the command “adb forward tcp:100 tcp:200” corresponds the TCP port 200 of the Android data processing system with the TCP port 100 of the external display device (for example, an on-board unit) which executes the Android adjustment bridge. Thus, the Android data processing system opens the socket for TCP port 200 and the external display device (for example, an on-board unit) opens the socket for TCP port 100. The Android data processing system and the external display device may communicate with each other.

Thus, the communication channel is implemented by corresponding the TCP port of Android data processing system and the TCP port of the external display device. Practically, the communication channel is a USB cable.

Besides, the communication channel in the application may be implemented by the USB network share.

In the embodiment of the application, the image data transmission between the Android data processing system and the external display device may be achieved even without WiFi wireless network or any wired network. The embodiment of the application is suitable in the environment where wireless data transmission is not available, for example, in the flying airplane or in the situation that a car drives into an area having poor wireless signal strength. Thus, the image data transmission between the Android data processing system and the external display device has wider application field. Further, in the embodiment of the application, the image data transmission between the Android data processing system and the external display device does not occupy the network bandwidth, the operations are convenient and simple, and the delay in the image display procedure is prevented.

The image display module 122 is for processing and displaying the received images displayed on the virtual display of the Android data processing system.

In the embodiment of the application, the external display device is coupled to the Android data processing system via a communication channel and receives the images displayed on the virtual display of the Android data processing system from the Android data processing system via a communication channel. The received images displayed on the virtual display of the Android data processing system are processed and displayed. Thus, the images displayed on the virtual display are sent to the external display device for image mirror display via the communication channel. In the application, the network bandwidth is not occupied, the operations are convenient and simple, and the delay in the image display procedure is prevented.

The devices provided in the above embodiments of the application may be implemented by computer procedures. Person skilled in the art would understand that the above implementations of the elements and the modules are one of possible implementations. If the elements or the modules are divided or segmented as other types, or even if the elements or the module are integrated together, as long as the above functions are achieved, these are still within the scope of the application.

Person skilled in the art should understand that the embodiments of the application may be implemented as a method, a device (or an apparatus) or a computer program product. Thus, the application may be implemented as pure hardware embodiments, pure software embodiments or embodiments having combination of hardware and software. Further, the application may be implemented as a computer program product which is implemented on one or more computer readable storage media (including for example but not limited by, a magnetic disk, a CD-ROM, an optical storage medium etc.) having computer readable program codes.

Description of the application is accompanied with the flow charts and/or the block diagram of the methods, the devices (apparatus) and the computer program product. It should be noted that the computer program codes may be used to implement each flow and/or block of the flow charts and/or the block diagram, or combination of the flows and/or blocks of the flow charts and/or the block diagram. The computer program codes may be provided to a general computer, a dedicated computer, an embedded processor or a processor of other programmable data processing device to form a machine, and a computer or a processor of other programmable data processing device may be used to form devices which may implement functions specified by one or more flows of the flow chart and/or one or more blocks of the block diagram.

The computer program codes may be stored in a computer readable storage which may guide a computer or other programmable data processing device in a specific operation way, so that codes of the computer readable storage includes a manufacture of command devices which implement functions specified by one or more flows of the flow chart and/or one or more blocks of the block diagram.

The computer program codes may be loaded into a computer or other programmable data processing device which executes a series of operation steps to generate computer-implemented processes. Thus, commands executed on a computer or other programmable data processing device may be provided to implement functions specified by one or more flows of the flow chart and/or one or more blocks of the block diagram.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. An image mirror display method for an Android data processing system, the method including:
executing a pre-stored virtual display screen record procedure by an Android Shell user privilege for obtaining images displayed on a virtual display of the Android data processing system, wherein the images displayed on the virtual display are the same as current images displayed on an internal display of the Android data processing system;
processing and storing the images displayed on the virtual display of the Android data processing system; and
sending the stored images displayed on the virtual display of the Android data processing system to an external display device via a communication channel, wherein the Android data processing system and the external display device are coupled via the communication channel.

2. The method according to claim 1, wherein pre-storage of the virtual display screen record procedure includes the following steps:
storing the virtual display screen record procedure into a storage space of the Android data processing system by a record command of an Android adjustment bridge ADB;
encoding and storing an Android Java procedure into the Android data processing system to obtain a directory space controlled by the Android Java procedure;
executing the Android Java procedure to record the virtual display screen record procedure stored in the storage space of the Android data processing system into the directory space controlled by the Android Java procedure; and
informing the Android Shell user privilege about a name of the directory space, and amending a document property of the virtual display screen record procedure as an executable document which is executable by other user privilege.

3. The method according to claim 2, wherein the Android Java procedure is stored into the Android data processing system in form of an Android application package apk.

4. The method according to claim 3, wherein execution of the pre-stored virtual display screen record procedure by the Android Shell user privilege is achieved by executing the virtual display screen record procedure stored in the directory space via an adb Shell command input into the Android data processing system.

5. The method according to claim 1, wherein pre-storage of the virtual display screen record procedure includes the following steps:
storing the virtual display screen record procedure into a directory (which is writable by the Android Shell user privilege) of a storage space of the Android data processing system by a record command of an Android adjustment bridge ADB; and
amending a property of the virtual display screen record procedure as an executable document having “s-property” via an adb Shell command of the Android adjustment bridge ADB.

6. The method according to claim 1, wherein pre-storage of the virtual display screen record procedure includes the following steps:
establishing a new directory in a directory (which is writable by the Android Shell user privilege) of a storage space of the Android data processing system;
setting a property of the new directory as “t-property” via a record command of an Android adjustment bridge ADB;
storing the virtual display screen record procedure into the new “t-property” directory of the storage space of the Android data processing system by the record command of the Android adjustment bridge ADB; and
amending a property of the virtual display screen record procedure as an executable document having “s-property” via the record command of the Android adjustment bridge ADB.

7. The method according to claim 6, wherein the step of executing the pre-stored virtual display screen record procedure by the Android Shell user privilege is achieved by calling the virtual display screen record procedure by a procedure of an Android application package apk.

8. The method according to claim 1, wherein the step of processing and storing the current images displayed on the internal display of the Android data processing system is to compress the current images displayed on the internal display into a video stream flow compatible with H.264 standard.

9. The method according to claim 7, wherein a multimedia frame structure processing flow “Stagefright” of Android is used to process the current images displayed on the internal display.

10. The method according to claim 8, wherein a hardware encoder is used to compress the current images displayed on the internal display into a video stream flow compatible with H.264 standard.

11. The method according to claim 1, wherein the communication channel is implemented by corresponding a TCP port of the Android data processing system with a TCP port of the external display device.

12. The method according to claim 10, wherein the communication channel is implemented by a USB cable.

13. The method according to claim 1, wherein the communication channel is implemented by USB network share.

14. The method according to claim 1, further including:
amending a property of a SELinux context of the virtual display screen record procedure by a command, and thus the virtual display screen record procedure is executed by the Android Shell user privilege.

15. An image mirror display method for an external display device, the method including:
receiving images displayed on a virtual display of an Android data processing system from the Android data processing system by the external display device via a communication channel, wherein the external display device is coupled to the Android data processing system via the communication channel, and the images displayed on the virtual display are the same as images currently displayed on an internal display of the Android data processing system; and
processing and displaying the received images displayed on the virtual display of the Android data processing system.

16. The method according to claim 15, wherein the communication channel is implemented by corresponding a TCP port of the Android data processing system with a TCP port of the external display device.

17. The method according to claim 16, wherein the communication channel is implemented by a USB cable.

18. The method according to claim 15, wherein the communication channel is implemented by USB network share.

19. An image mirror display device for an Android data processing system, the device including:
an image obtaining module, for executing a pre-stored virtual display screen record procedure by an Android Shell user privilege to obtain images displayed on a virtual display of the Android data processing system, wherein the images displayed on the virtual display are the same as current images displayed on an internal display of the Android data processing system;
an image processing module, for processing and storing the images displayed on the virtual display of the Android data processing system; and
an image transmission module, coupled to an external display device via a communication channel, for sending the stored images displayed on the virtual display of the Android data processing system to the external display device via the communication channel.

20. An image mirror display device for an external display device, the device including:
an image receiving module, for receiving images displayed on a virtual display of an Android data processing system from the Android data processing system via a communication channel, wherein the external display device is coupled to the Android data processing system via the communication channel, and the images displayed on the virtual display are the same as images currently displayed on an internal display of the Android data processing system; and
an image display module, for processing and displaying the received images displayed on the virtual display of the Android data processing system.
